(19) United States
(12) Patent Application Publication
(10) Pub. No.: US 2024/0029320 A1
(43) Pub. Date: Jan. 25, 2024

(54) IMAGE PROCESSING SYSTEM AND IMAGE OBJECT SUPERIMPOSITION APPARATUS AND METHOD THEREOF

(71) Applicant: SigmaStar Technology Ltd., Xiamen (CN)

(72) Inventors: Chao WANG, Shanghai (CN); Meng PU, Shanghai (CN); Ming-Yong SUN, Shanghai (CN)

(21) Appl. No.: 18/070,651

(22) Filed: Nov. 29, 2022

(30) Foreign Application Priority Data
Jul. 22, 2022 (CN) 202210869009.0

(51) Int. Cl. G06T 11/00; G06T 1/20; G06V 20/00; G06T 3/40

(52) U.S. Cl. CPC G06T 11/00; G06T 1/20; G06V 20/00; G06T 3/40; G06T 2210/32

(57) ABSTRACT

An image object superimposition apparatus includes an object identification circuit, a graphics rendering circuit, a graphics processing circuit and a superimposition circuit. The object identification circuit identifies a plurality of objects included in an original image to generate object identification information. The graphics rendering circuit renders, according to the object identification information, a plurality of object frames to be stored to a memory. The object frames correspond to objects, respectively, and have a total memory usage smaller than a data size of the original image. The graphics processing circuit includes a plurality of graphics processing unit circuits, which process the object frames to generate a plurality of processed object frames. The superimposition circuit superimposes the processed object frames on the original image to further output a synthesized image.

This application claims the benefit of China application Serial No. CN202210869009.0, filed on Jul. 22, 2022, the subject matter of which is incorporated herein by reference.

### BACKGROUND OF THE INVENTION

### Field of the Invention

The present application relates to an image object superimposition technique, and more particularly, to an image processing system and an image object superimposition apparatus and method thereof.

### Description of the Related Art

Image capturing devices are greatly used in the lives of modern people. For example, cell phones capable of capturing videos and surveillance systems that record videos over a long period of time both adopt image capturing devices. Object identification is a critical technique derived from image capturing devices, and can be applied to identify specific objects such as human faces and license plates of vehicles.

In conventional object identification, an image processing device frequently sets a large frame for all objects to cover all of the objects, so as to label and store the range in which the objects are present. However, in the processing approach above, in case of dispersed objects, an image range including an overly large amount of non-object contents is also stored, resulting in the waste of memory. Moreover, the form of one single frame cannot provide different settings with respect to individual objects, hence yielding inadequate application flexibilities.

### SUMMARY OF THE INVENTION

In view of the issues of the prior art, it is an object of the present application to provide an image processing system and an image object superimposition apparatus and method thereof so as to improve the prior art.

An image object superimposition apparatus provided by the present application includes an object identification circuit, a graphics rendering circuit, a graphics processing circuit and a superimposition circuit. The object identification circuit identifies a plurality of objects included in an original image to generate object identification information. The graphics rendering circuit renders, according to the object identification information, a plurality of object frames to be stored to a memory. The object frames correspond to objects, respectively, and have a total memory usage smaller than a data size of the original image. The graphics processing circuit includes a plurality of graphics processing unit circuits, which process the object frames to generate a plurality of processed object frames. The superimposition circuit superimposes the processed object frames on the original image to further output a synthesized image.

An image object superimposition method applied in an image object superimposition apparatus is further provided by the present application. The method includes: identifying, by an object identification circuit, a plurality of objects included in an original image to generate object identification information; rendering, by a graphics rendering circuit according to the object identification information, a plurality of object frames to be stored to a memory, wherein the object frames respectively correspond to objects and have a total memory usage smaller than a data size of the original image; processing, by a plurality of graphics processing unit circuits included in a graphics processing circuit, the object frames to generate a plurality of processed object frames; and superimposing, by the superimposition circuit, the processed object frames on the original image to further output a synthesized image.

An image processing system is further provided by the present application. The image processing system includes an image capturing apparatus, a memory, an image object superimposition apparatus and a display apparatus. The image capturing apparatus performs image capturing to generate an original image. The image object superimposition apparatus includes an object identification circuit, a graphics rendering circuit, a graphics processing circuit and a superimposition circuit. The object identification circuit receives the original image, and identifies a plurality of objects included in an original image to generate object identification information. The graphics rendering circuit renders, according to the object identification information, a plurality of object frames to be stored to a memory. The object frames correspond to objects, respectively, and have a total memory usage smaller than a data size of the original image. The graphics processing circuit includes a plurality of graphics processing unit circuits, which process the object frames to generate a plurality of processed object frames. The superimposition circuit superimposes the processed object frames on the original image to further output a synthesized image. The display apparatus receives and displays the synthesized image.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a block diagram of an image processing system according to an embodiment of the present application;

FIG. 2 is a block diagram of a memory and an image object superimposition apparatus according to an embodiment of the present application;

FIG. 3 is a schematic diagram of an original image according to an embodiment of the present application;

FIG. 4 is a schematic diagram of object frames according to an embodiment of the present application;

FIG. 5 is a block diagram of an image processing circuit according to an embodiment of the present application;

FIG. 6 is a block diagram of an image processing circuit and a superimposition circuit according to another embodiment of the present application; and

FIG. 7 is a flowchart of an image object superimposition method according to an embodiment of the present application.

### DETAILED DESCRIPTION OF THE INVENTION

It is an object of the present application to provide an image processing system and an image object superimposition apparatus and method thereof, which identify individual objects and render object frames. Thus, a memory usage is significantly reduced, and different types of processing can be performed on object frames according to requirements, achieving flexible display effects.

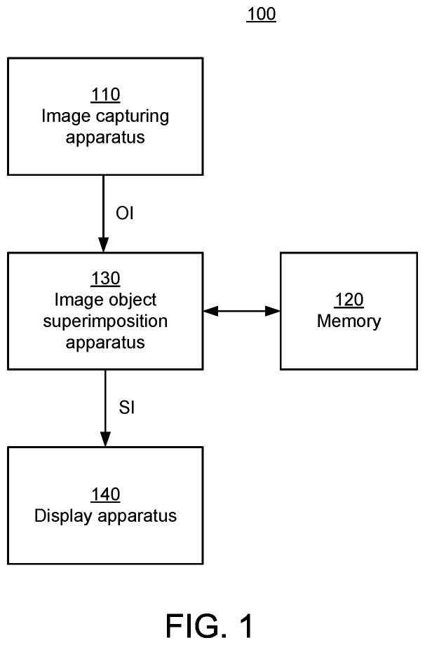

Refer to FIG. 1. FIG. 1 shows a block diagram of an image processing system 100 according to an embodiment of the present application. The image processing system 100 includes an image capturing apparatus 110, a memory 120, an image object superimposition apparatus 130 and a display apparatus 140.

The image capturing apparatus 110 may include one or more photosensitive elements, and perform image capturing to generate an original image OI.

The image object superimposition apparatus 130 receives the original image OI, performs object identification, and accordingly renders and superimposes corresponding object frames on the original image OI to generate a synthesized image SI. In one embodiment, in addition to object superimposition, the image object superimposition apparatus 130 may also selectively perform processing of, for example but not limited to, auto focusing, auto exposure, auto white balance, high dynamic range imaging (HDRI), noise reduction or a combination thereof to generate the synthesized image SI.

The display apparatus 140 receives and displays the synthesized image SI.

In different applications, the image processing system 100 may be a video surveillance system, an image capturing system or other electronic systems capable of capturing, processing and displaying images. The original image OI may be an image in an original image stream, and the synthesized image SI may also be an image in a synthesized image stream. With the processing of the image object superimposition apparatus 130, the synthesized image SI can include object frames corresponding to different objects without affecting the original image OI, thus facilitating subsequent data processing.

The structure and operation of the image object superimposition apparatus 130 are to be described in detail below.

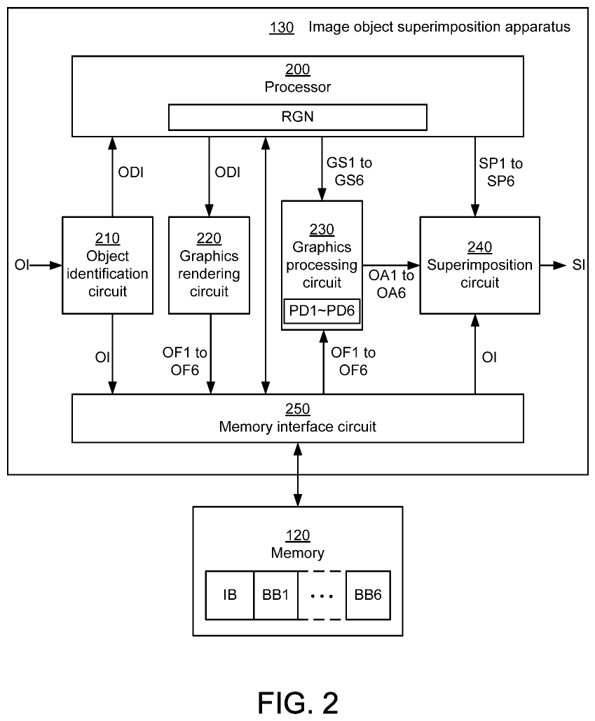

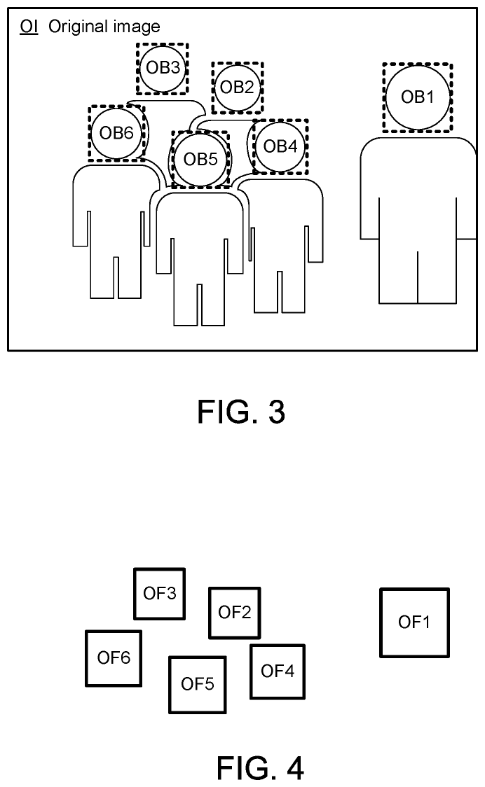

Refer to FIG. 2 and FIG. 3. FIG. 2 shows a block diagram of the memory 120 and the image object superimposition apparatus 130 according to an embodiment of the present application. FIG. 3 shows a schematic diagram of the original image OI according to an embodiment of the present application.

As shown in FIG. 2, the image object superimposition apparatus 130 includes a processor 200, an object identification circuit 210, a graphics rendering circuit 220, a graphics processing circuit 230, a superimposition circuit 240 and a memory interface circuit 250.

The processor 200 operates resource configuration software RGN to set and control the circuits.

The object identification circuit 210 receives the original image OI, and identifies a plurality of objects included in an original image OI to generate object identification information ODI.

As shown in FIG. 3, the original image OI includes six objects OB1 to OB6. In FIG. 3, the objects OB1 to OB6 are exemplified by human faces; however, in other embodiments, they may be such as, for example but not limited to, license plates of vehicles, or other objects that need to be processed and identified according to actual requirements.

In one embodiment, the object identification information ODI may include, for example but not limited to, distance information of the individual objects OB1 to OB6 in the original image OI. In one embodiment, when all of the objects are objects of the same attribute (for example, all human faces), the distance information may be determined by the sizes of the objects. For example, an object having a larger size may be determined as having a relatively closer position; an object having a smaller size may be determined as having a relatively farther position.

It should be noted that the definition and acquisition means for the information above serve merely as examples. The present application is not limited to the above examples.

The memory 120 stores data, and can be accessed by the processor 200, the object identification circuit 210, the graphics rendering circuit 220, the graphics processing circuit 230 and the superimposition circuit 240. In one embodiment, the memory 120 is, for example but not limited to, a dynamic random access memory (DRAM), and the above circuits can access the memory 120 through the memory interface circuit 250.

The memory 120 includes an original image storage block IB and a plurality of object storage blocks BB1 to BB6. The original image storage block IB stores the original image OI. In one embodiment, the object identification circuit 210 can store the original image OI in the original image storage block IB after receiving the original image OI.

The graphics rendering circuit 220 receives the object identification information ODI and operates accordingly. In one embodiment, the object identification information ODI may be selectively transmitted to the graphics rendering circuit 220 by the resource configuration software RGN operated by the processor 200, or be directly transmitted to the graphics rendering circuit 220 by the object identification circuit 210.

The graphics rendering circuit 220 renders, according to the object identification information ODI, a plurality of object frames OF1 to OF6 to be stored to the object storage blocks BB1 to BB6.

Refer to FIG. 4. FIG. 4 shows a schematic diagram of the object frames OB1 to OB6 according to an embodiment of the present application.

As shown in FIG. 4, the object frames OF1 to OF6 correspond to the objects OB1 to OB6 in FIG. 3, respectively, and borders of the object frames OF1 to OF6 drawn in solid lines correspond to object ranges represented by dotted lines in FIG. 3, respectively. In one embodiment, the graphics rendering circuit 220 is a circuit having a graphics engine, and renders the object frames OF1 to OF6 according to the object identification information ODI.

In one embodiment, the correspondence between the object frames OF1 to OF6 and the object storage blocks BB1 to BB6 can be set by the resource configuration software RGN according to the object identification information ODI. More specifically, upon receiving the object identification information ODI, the resource configuration software RGN can learn the number, coordinates and sizes of the objects OB1 to OB6.

The resource configuration software RGN requests the memory 120 for the corresponding object storage blocks BB1 to BB6, which have the number and sizes sufficient for storing the object frames OF1 to OF6. The resource configuration software RGN can record the sizes and addresses of the object storage blocks BB1 to BB6. A total usage of the memory 120 by the object frames OF1 to OF6 is smaller than the data size of the original image OI.

The graphics processing circuit 230 includes a plurality of graphics processing unit circuits PD1 to PD6, which process the object frames OF1 to OF6 and generate a plurality of processed object frames OA1 to OA6, respectively.

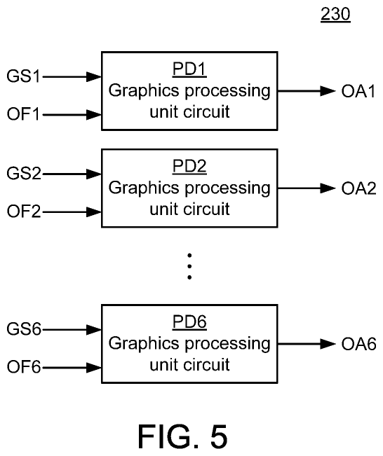

Refer to FIG. 5. FIG. 5 shows a block diagram of the image processing circuit 230 according to an embodiment of the present application. The graphics processing circuit 230 includes the plurality of graphics processing unit circuits PD1 to PD6.

Upon receiving the object identification information ODI, the resource configuration software RGN can accordingly determine processing needed for the individual object frames OF1 to OF6, and notify the graphics processing unit circuits PD1 to PD6 of the sizes and addresses of the object storage blocks BB1 to BB6 corresponding to the object frames OF1 to OF6, for the graphics processing unit circuits PD1 to PD6 to accordingly read and process the object frames OF1 to OF6.

The graphics processing circuit 230 processes the object frames OF1 to OF6 by, for example but not limited to, scaling up and scaling down of frames, graphic format conversion or a combination thereof.

In one embodiment, the graphics processing circuit 230 can process the object frames OF1 to OF6 according to graphics processing parameters GS1 to GS6 including scaling parameters. The resource configuration software RGN can write information such as the graphics processing parameters GS1 to GS6 and the addresses of the object storage blocks BB1 to BB6 to registers (not shown) corresponding to the graphics processing unit circuits PD1 to PD6, for the graphics processing unit circuits PD1 to PD6 to read and operate accordingly.

In one embodiment, the graphics processing unit circuits PD1 to PD6 perform format conversion on the object frames OF1 to OF6, which then can have the same image format as the original image OI. The image format of the original image OI may be, for example but not limited to, ARGB8888 or AYUV8888. The graphics processing unit circuits PD1 to PD6 can convert and configure the format of the object frames OF1 to OF6 to be one of the two formats above, so as to correspond to the image format of the original image OI.

In practice, the graphics processing unit circuits PD1 to PD6 may be implemented by, for example but not limited to, application specific integrated circuits (ASIC).

The superimposition circuit 240 superimposes the processed object frames OA1 to OA6 on the original image OI to further output the synthesized image SI. In one embodiment, the resource configuration software RGN can configure a set of superimposition parameters SP1 to SP6 according to the object identification information ODI, for the superimposition circuit 240 to perform superimposition according to the superimposition parameters SP1 to SP6. The resource configuration software RGN can write information of the superimposition parameters SP1 to SP6 to a register (not shown) corresponding to the superimposition circuit 240, for the superimposition circuit 240 to read and operate accordingly.

In one embodiment, the superimposition parameters SP1 to SP6 include a graphic order level. For example, the resource configuration software RGN can set the graphic order level according to the distance information in the object identification information ODI. When one (for example, the object OB1) of the objects therein is located at a relatively closer position, the corresponding one (for example, the processed object frame OA1) of the processed object frames has a higher graphic order level. When one (for example, the object OB3) of the objects therein is located at a relatively farther position, the corresponding one (for example, the processed object frame OA3) of the processed object frames has a lower graphic order level. In one embodiment, the original image OI is set to have the lowest graphic order level.

In another embodiment, the superimposition parameters SP1 to SP6 include a transparency, which can be set to be corresponding to the graphic order level. When one of the objects therein is located at a relatively closer position, the corresponding one of the processed object frames has a higher graphic order level as well as a lower transparency. When one of the objects therein is located at a relatively farther position, the corresponding one of the processed object frames has a lower graphic order level as well as a higher transparency.

In one embodiment, the superimposition circuit 240 can perform superimposition in a pixel-by-pixel manner. With the superimposition position set by the resource configuration software RGN, the superimposition circuit 240 can determine whether each target pixel in the original image OI corresponds to a position in any of the processed object frames OA1 to OA6. If the target pixel corresponds to the range of any of the processed object frames OA1 to OA6, the superimposition circuit 240 receives pixel data of the corresponding processed object frames OA1 to OA6, and performs superimposition thereto with the target pixel of the original image OI. If the target pixel does not correspond to the range of any of the processed object frames OA1 to OA6, the superimposition circuit 240 directly outputs the target pixel of the original image OI.

In one embodiment, when the target pixel corresponds to the range of any of the plurality of processed object frames OA1 to OA6, the superimposition circuit 240 can output the pixel data of one (for example, the one having the highest graphic order level) of the processed object images OA1 to OA6 according to the graphic order levels, and superimpose the output pixel data with the target pixel of the original image OI.

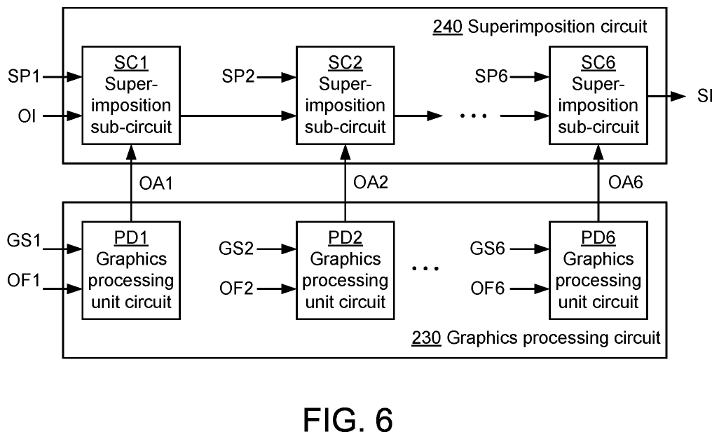

Refer to FIG. 6. FIG. 6 shows a block diagram of the image processing circuit 230 and the superimposition circuit 240 according to another embodiment of the present application. Similar to the graphics processing circuit 230 in FIG. 5, the graphics processing circuit 230 in FIG. 6 includes the plurality of graphics processing unit circuits PD1 to PD6. However, in this embodiment, the superimposition circuit 240 further includes a plurality of superimposition sub-circuits SC1 to SC6.

The superimposition sub-circuits SC1 to SC6 correspond to the graphics processing unit circuits PD1 to PD6, respectively. Starting from the first superimposition sub-circuit SC1 to the sixth superimposition sub-circuit SC6, the processed object frames OA1 to OA6 are superimposed on the original image OI according to the superimposition parameters SP1 to SP6 respectively, wherein the last superimposition sub-circuit SC6 outputs the synthesized image SI.

In one embodiment, the superimposition sub-circuits SC1 to SC6 can be set to superimpose the individual object frames OA1 to OA6 according to an order of the graphic order levels, and are not required to perform superimposition according to the order in FIG. 6.

In some techniques, although objects in an original image can be individually identified, one single large frame that covers all objects needs to be drawn. When objects are in a dispersed distribution in an original image, the frame may be caused to include an overly large amount of non-object image contents, resulting in waste of memory usage. Moreover, the form of one single frame cannot provide different settings with respect to individual objects, hence yielding inadequate application flexibilities.

The image object superimposition apparatus of the present application is capable of identifying individual objects and rendering object frames. Thus, a memory usage is significantly reduced, and different types of processing can be performed on object frames according to requirements, achieving flexible display effects.

It should be noted that, in the above embodiments, the numbers of the objects, object frames and processed object frames are merely examples. In practice, the numbers of the objects, object frames and processed object frames may vary according to different original images received. The present application is not limited to the above examples.

Moreover, in the above embodiments, the contents included in the object identification information, graphic setting parameters and superimposition parameters are similarly merely examples. In practice, the contents included in the object identification information, graphic setting parameters and superimposition parameters may vary according to actual requirements. The present application is not limited to the above examples.

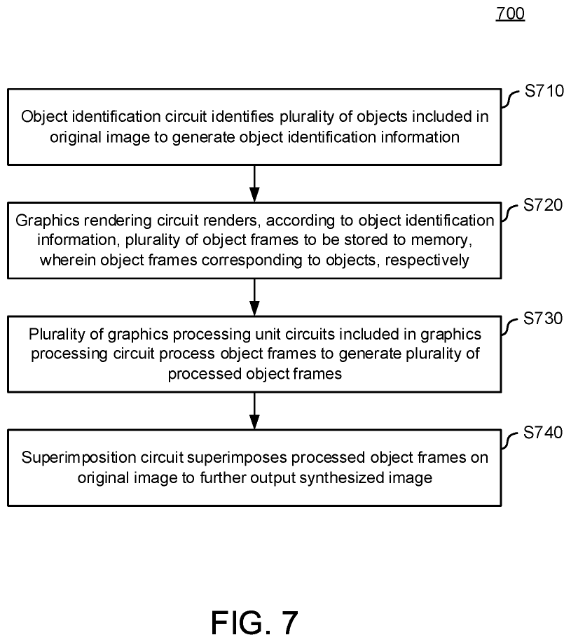

Refer to FIG. 7. FIG. 7 show a flowchart of an image object superimposition method 700 according to an embodiment of the present application.

In addition to the above apparatus, the present application further discloses an image object superimposition method 700 applied to, for example but not limited to, the image object superimposition apparatus 130 in FIG. 2. As shown in FIG. 7, the image object superimposition method 700 according to an embodiment includes the following steps.

In step S710, an object identification circuit 210 identifies a plurality of objects OB1 to OB6 included in an original image OI to generate object identification information ODI.

In step S720, a graphics rendering circuit 220 renders, according to the object identification information ODI, a plurality of object frames OF1 to OF6 to be stored to a memory 120. The object frames OF1 to OF6 correspond to the objects OB1 to OB6, respectively, and have a total usage of a memory 120 smaller than a data size of the original image OI.

In step S730, a plurality of graphics processing unit circuits PD1 to PD6 included in a graphics processing circuit 230 process the object frames OF1 to OF6 to generate a plurality of processed object frames OA1 to OA6.

In step S740, a superimposition circuit 240 superimposes the processed object frames OA1 to OA6 on the original image OI to further output a synthesized image SI.

In practice, the numbers of the objects, object frames and processed object frames may vary according to different original images received. Moreover, the contents included in the object identification information, graphic setting parameters and superimposition parameters may vary according to actual requirements. The present application is not limited to the above examples.

It should be noted that the embodiments above serve as merely examples. In other embodiments, modifications may be made by a person skilled in the art without departing from the spirit of the disclosure. It should be understood that the steps described in the embodiments above, unless the orders are otherwise specified, may have orders adjusted according to actual requirements, or the steps may all or partially be performed simultaneously.

The image processing system and the image object superimposition apparatus and method thereof of the present application are capable of identifying individual objects and rendering object frames. Thus, a memory usage is significantly reduced, and different types of processing can be performed on object frames according to requirements, achieving flexible display effects.

While the present application has been described by way of example and in terms of the preferred embodiments, it is to be understood that the present application is not limited thereto. On the contrary, it is intended to cover various modifications and similar arrangements and procedures, and the scope of the appended claims therefore should be accorded with the broadest interpretation so as to encompass all such modifications and similar arrangements and procedures.

What is claimed is:

1. An image object superimposition apparatus, comprising:
an object identification circuit, configured to identify a plurality of objects included in an original image to generate object identification information;
a graphics rendering circuit, configured to render, according to the object identification information, a plurality of object frames to be stored to a memory, wherein the object frames correspond to objects, respectively, and have a total memory usage smaller than a data size of the original image;
a graphics processing circuit, comprising a plurality of graphics processing unit circuits, the graphics processing unit circuits processing the object frames to generate a plurality of processed object frames; and
a superimposition circuit, configured to superimpose the processed object frames on the original image to output a synthesized image.

2. The image object superimposition apparatus according to claim 1, wherein the object identification information comprises individual distance information of the objects in the original image.

3. The image object superimposition apparatus according to claim 1, further comprising:
a processor, configured to operate resource configuration software, the resource configuration software configuring a set of superimposition parameters according to the object identification information.

4. The image object superimposition apparatus according to claim 3, wherein the set of superimposition parameters comprise a graphic order level.

5. The image object superimposition apparatus according to claim 4, wherein while the resource configuration software sets the graphic order level, when one of the object is at a relatively closer position, the corresponding one of the processed object frames has a higher of the graphic order level, and when one of the objects is located at a relatively farther position, the corresponding one of the processed object frames has a lower of the graphic order level, wherein the original image has a lowest of the graphic order level.

6. The image object superimposition apparatus according to claim 1, wherein the graphics processing unit circuits process the object frames according to a scaling parameter.

7. The image object superimposition apparatus according to claim 1, wherein the graphics processing unit circuits perform format conversion on the object frames according to an image format of the original image.

8. The image object superimposition apparatus according to claim 4, wherein the superimposition circuit comprises a plurality of superimposition sub-circuits, and the superimposition sub-circuits correspond to the graphics processing unit circuits, respectively, to sequentially superimpose the processed object frames on the original image according to the set of superimposition parameters, respectively.

9. An image object superimposition method applied to an image object superimposition apparatus, comprising:
identifying, by an object identification circuit, a plurality of objects included in an original image to generate object identification information;
rendering, by a graphics rendering circuit according to the object identification information, a plurality of object frames to be stored to a memory, wherein the object frames correspond to objects, respectively, and have a total memory usage smaller than a data size of the original image;
processing, by a plurality of graphics processing unit circuits included in a graphics processing circuit, the object frames to generate a plurality of processed object frames; and
superimposing, by a superimposition circuit, the processed object frames on the original image to further output a synthesized image.

10. The image object superimposition method according to claim 9, wherein the object identification information comprises individual distance information of the objects in the original image.

11. The image object superimposition method according to claim 9, further comprising:
operating, by a processor, resource configuration software to configure a set of superimposition parameters according to the object identification information.

12. The image object superimposition method according to claim 11, wherein the set of superimposition parameters comprise a graphic order level.

13. The image object superimposition method according to claim 12, wherein when one of the object is at a relatively closer position, the corresponding one of the processed object frames has a higher of the graphic order level, and when one of the objects is located at a relatively farther position, the corresponding one of the processed object frames has a lower of the graphic order level, wherein the original image has a lowest of the graphic order level.

14. The image object superimposition method according to claim 9, wherein the graphics processing unit circuits process the object frames according to a scaling parameter.

15. The image object superimposition method according to claim 9, wherein the graphics processing unit circuits perform format conversion on the object frames according to an image format of the original image.

16. The image object superimposition method according to claim 12, wherein the superimposition circuit comprises a plurality of superimposition sub-circuits, and the superimposition sub-circuits correspond to the graphics processing unit circuits, respectively, to sequentially superimpose the processed object frames on the original image according to the set of superimposition parameters, respectively.

17. An image processing system, comprising:
an image capturing apparatus, configured to perform image capturing to generate an original image;
a memory;
an image object superimposition apparatus, comprising:
an object identification circuit, configured to receive the original image and identify a plurality of objects included in an original image to generate object identification information;
a graphics rendering circuit, configured to render, according to the object identification information, a plurality of object frames to be stored to the memory, wherein the object frames correspond to objects, respectively, and have a total memory usage smaller than a data size of the original image;
a graphics processing circuit, comprising a plurality of graphics processing unit circuits, the graphics processing unit circuits processing the object frames to generate a plurality of processed object frames; and
a superimposition circuit, configured to superimpose the processed object frames on the original image to further output a synthesized image; and
a display apparatus, configured to receive and display the synthesized image.
